(19) United States
(12) Patent Application Publication
(10) Pub. No.: US 2017/0159588 A1
(43) Pub. Date: Jun. 8, 2017

(54) FUEL VAPOR PROCESSING SYSTEM AND METHOD FOR OPERATING FUEL VAPOR PROCESSING SYSTEM

(71) Applicant: MAZDA MOTOR CORPORATION, Hiroshima (JP)

(72) Inventor: Takuya HONJO, Hiroshima-shi (JP)

(73) Assignee: MAZDA MOTOR CORPORATION, Hiroshima (JP)

(21) Appl. No.: 15/366,756

(22) Filed: Dec. 1, 2016

(30) Foreign Application Priority Data
Dec. 7, 2015 (JP) 2015-238585

(51) Int. Cl. F02D 41/00; F02D 41/26; B01D 53/04; F02M 25/08

(52) U.S. Cl. CPC F02D 41/0045; F02M 25/0836; F02M 25/089; F02D 41/263; B01D 53/0454; B01D 53/0446; B01D 2257/7022; B01D 2259/4516

(57) ABSTRACT

The invention is a method for operating a fuel vapor processing system. The fuel processing system includes: a purge passage; a canister configured to receive and store therein fuel vapor from a fuel tank; a pressurizer pump; a purge valve; and a pressure sensor configured to detect a pressure in a detection section between said pressurizer pump and said purge valve. The method includes: when determined that said engine is under said specific engine condition, closing said purge valve; operating said pressurizer pump to pump a gas, which contains the fuel vapor stored in said canister, into said detection section; and estimating concentration of the fuel vapor in the gas residing in said detection section based on a signal from said pressure sensor detected after a pressure increase in said detection section, and controlling said purge valve to be further opened as the estimated fuel vapor concentration is lower.

### TECHNICAL FIELD

The present invention relates to a fuel vapor processing system, and more particularly to a fuel vapor processing system capable of calculating a concentration of fuel vapor and processing the fuel vapor based on the calculated concentration.

### BACKGROUND ART

Heretofore, there has been known a fuel vapor processing system for processing fuel vapor generated in a fuel tank of an automotive vehicle. A commonly-used fuel vapor processing system comprises a purge passage extending between a fuel tank and an intake pipe connected to an upstream side of an internal combustion engine. Further, on the purge passage, there is provided a canister comprised of activated charcoal and configured to receive and store therein fuel vapor flowing from the fuel tank. Thus, fuel vapor in the fuel tank is discharged from the fuel tank, and stored in the canister via the purge passage. When supplying the fuel vapor stored in the canister to the engine intake pipe, at a predetermined purge timing, an opening degree of a throttle valve in the engine intake pipe is reduced to generate a negative pressure in the purge passage. Thus, the fuel vapor stored in the canister is sucked toward a downstream side of the purge passage and supplied to the engine via the engine intake pipe.

Meanwhile, in recent years, with a view to improving fuel economy, there has been an increasing need to precisely control a combustion condition, particularly an air-fuel ratio, in engine cylinders. Thus, in advance of supplying the fuel vapor to the engine, it is required to accurately measure concentration of the fuel vapor to be supplied to the engine cylinder, so as to achieve a target air-fuel ratio when the fuel vapor has been supplied in the engine cylinders. In this regard, JP 2009-138561A (Patent Document) has been known as one example of a technique capable of measuring the fuel vapor concentration.

### PATENT DOCUMENT LIST

JP 2009-138561A

### SUMMARY OF INVENTION

### Technical Problem

A fuel vapor processing system described in JP 2009-138561A is configured to generate a negative pressure in a purge passage by reducing an opening degree of a throttle valve, to thereby suck the fuel vapor stored in a canister toward an engine intake pipe. Meanwhile, in recent years, the development of a system for reducing pumping loss in an internal combustion engine has been promoted, wherein the system is configured to keep a throttle valve disposed on an upstream side of the engine in a full open state. Thus, this system has few opportunities to reduce an opening degree of the throttle valve, so that there is a problem that it is unable to generate a negative pressure for sucking from the canister the fuel vapor stored in the canister.

Further, while a technique of automatically stopping an internal combustion engine during a brief stop of a vehicle has recently been propagated with a view to improving fuel economy, this technique is disadvantageous because the fuel vapor purge is performed in a predetermined engine operating state during an engine drive, as mentioned above. That is, in a vehicle employing such an engine auto-stop system, particularly, a time period of engine drive becomes shorter, so that opportunities to purge the fuel vapor stored in the canister decrease. As measures against a decrease in purge amount of the fuel vapor caused by the decrease in purge opportunities, it is conceivable to continuously purge a large amount of fuel vapor during a predetermined engine operating state, irrespective of an amount of the fuel vapor stored in the canister. However, considering the aforementioned need to precisely control the air-fuel ratio in the engine cylinders, it is undesirable to simply increase the purge amount.

The present invention has been made to solve the above problems, and an object thereof is to provide a fuel vapor processing system capable of efficiently performing purge (a purge processing) without operating a throttle valve and even if opportunities to perform the purge are reduced due to some reasons such as employment of an engine auto-stop system, thereby making it possible to adequately process fuel vapor.

### Solution to Technical Problem

In order to solve the above problems, the present invention provides a fuel vapor processing system comprising: a purge passage connecting a fuel tank to an intake pipe of an internal combustion engine; a canister connected to a downstream side of said fuel tank on said purge passage and configured to receive and store therein fuel vapor from said fuel tank; a pressurizer pump connected to the downstream side of said canister on said purge passage; a purge valve connected to the downstream side of said pressurizer pump on said purge passage; a pressure sensor configured to detect a pressure in a detection section between said pressurizer pump and said purge valve on said purge passage; and a controller configured to: determine if said engine is under a specific engine condition; and when determined that said engine is under said specific engine condition, control said purge valve to be closed, control said pressurizer pump to be driven from a stop thereof to a predetermined condition to pump a gas, which contains the fuel vapor stored in said canister, into said detection section, and estimate concentration of the fuel vapor in the gas residing in said detection section based on a signal from said pressure sensor detected after a pressure increase in said detection section, which has been caused by pumping the gas containing the fuel vapor into said detection section, and control said purge valve to be opened as the estimated fuel vapor concentration is lower.

In the fuel vapor processing system of the present invention having the above feature, the pressurizer pump is provided between the canister on the purge passage and the purge valve, thereby making it possible to generate a negative pressure for sucking from the canister the fuel vapor stored in the canister. When a plurality of types of gases having different fuel vapor concentrations are pressurized under the same condition, a gas pressure becomes higher as the fuel vapor concentration becomes higher. Thus, the concentration of the fuel vapor contained in the gas residing in the detection section can be estimated by referring to the detection value (signal) from the pressure sensor obtained after the pressure increase in the detection section caused by pumping the fuel vapor-containing gas (the gas containing the fuel vapor) into the detection section, as in the present invention. Then, a purge processing of the fuel vapor stored in the canister is performed based on the estimated fuel vapor concentration, so that it is possible to control an air-fuel ratio in cylinders with a high degree of accuracy, while taking into account an amount of the fuel vapor to be introduced into the intake pipe.

Preferably, in the fuel vapor processing system of the present invention, said controller is operable to estimate the fuel vapor concentration, based on a difference between: a value of a pressure in said detection section when a gas not containing the fuel vapor is pumped into said detection section by said pressurizer pump; and a detection value from said pressure sensor detected after the pressure increase in said detection section caused by pumping the gas containing the fuel vapor into said detection section.

Preferably, in the above fuel vapor processing system, the value of the pressure in said detection section when the gas not containing the fuel vapor is pumped into said detection section is a value of a pressure generated in said detection section when said pressurizer pump is driven under said predetermined drive condition.

Preferably, the above fuel vapor processing system further comprises a memory storing therein the value of the pressure in said detection section when the gas not containing the fuel vapor is pumped into said detection section, which has been preliminarily measured.

Preferably, the above fuel vapor processing system further comprises a memory storing therein data indicative of a P-Q characteristic of said pressurizer pump when the gas not containing the fuel vapor is pumped, wherein the value of the pressure in said detection section when the gas not containing the fuel vapor is pumped into said detection section is a value of a pressure corresponding to said predetermined drive condition, indicated by said P-Q characteristic.

Preferably, in the above fuel vapor processing system, the memory stores therein data indicative of a plurality of P-Q characteristics of said pressurizer pump when the gas not containing the fuel vapor is pumped, the plurality of P-Q characteristics are associated with respective values of temperature of the gas to be pumped into the detection section, and the value of the pressure in said detection section when the gas not containing the fuel vapor is pumped into said detection section is a value of a pressure determined based on data indicative of one of the plurality of P-Q characteristics associated with a value of temperature of the gas detected by a temperature sensor.

Preferably, in the above fuel vapor processing system, the memory stores therein data indicative of a plurality of P-Q characteristics of said pressurizer pump when the gas not containing the fuel vapor is pumped, the plurality of P-Q characteristics are associated with respective values of outside air pressure, and the value of the pressure in said detection section when the gas not containing the fuel vapor is pumped into said detection section is a value of a pressure determined based on data indicative of one of the plurality of P-Q characteristics associated with a value of outside air pressure detected by an outside air pressure sensor.

Preferably, the fuel vapor processing system of the present invention further comprises a memory storing therein data indicative of a relationship of: a difference between a value of a pressure in said detection section when a gas not containing the fuel vapor is pumped into said detection section by said pressurizer pump, and a detection value from said pressure sensor detected after the pressure increase in said detection section caused by pumping the gas containing the fuel vapor into said detection section; and the fuel vapor concentration, wherein said controller is operable to estimate the fuel vapor concentration, based on said data.

Preferably, the fuel vapor processing system of the present invention further comprises a memory storing therein data indicative of a plurality of P-Q characteristics of the pressurizer pump with respect to respective values of fuel vapor concentration, wherein said controller is operable to select one of the plurality of P-Q characteristics which corresponds to a pressure in said detection section detected by the pressure sensor, and estimate that the fuel vapor concentration is one of the values of fuel vapor concentration associated with the selected P-Q characteristic.

The fuel vapor processing system having the above features can estimate the fuel vapor concentration with a high degree of accuracy.

In addition, the present invention provides a method for operating a fuel vapor processing system including: a purge passage connecting a fuel tank to an intake pipe of an internal combustion engine; a canister connected to a downstream side of said fuel tank on said purge passage and configured to receive and store therein fuel vapor from said fuel tank; a pressurizer pump connected to the downstream side of said canister on said purge passage; a purge valve connected to the downstream side of said pressurizer pump on said purge passage; and a pressure sensor configured to detect a pressure in a detection section between said pressurizer pump and said purge valve on said purge passage; the method comprising the steps of: determining if said engine is under a specific engine condition; and when determined that said engine is under said specific engine condition, closing said purge valve, operating said pressurizer pump from a stop thereof to a predetermined condition to pump a gas, which contains the fuel vapor stored in said canister, into said detection section, and estimating concentration of the fuel vapor in the gas residing in said detection section based on a signal from said pressure sensor detected after a pressure increase in said detection section, which has been caused by pumping the gas containing the fuel vapor into said detection section, and controlling said purge valve to be opened so as to purge a larger amount of the fuel vapor as the estimated fuel vapor concentration is lower.

### Effect of Invention

As mentioned above, the present invention can provide a fuel vapor processing system capable of generating a negative pressure in the purge passage without operating a throttle valve, and efficiently performing purge, thereby making it possible to adequately process fuel vapor.

### BRIEF DESCRIPTION OF DRAWINGS

FIG. 1 is a configuration diagram of a fuel vapor processing system according to one embodiment of the present invention.

FIG. 2 is a flowchart depicting an operation of the fuel vapor processing system according to this embodiment.

FIG. 3 is a graph depicting a P-Q characteristic of a pressurizer pump comprised in the fuel vapor processing system according to this embodiment.

FIG. 4 depicts a map used in the fuel vapor processing system according to this embodiment, wherein the map represents a relationship between a pressure difference (ΔP) and a concentration (p).

FIG. 5A and FIG. 5B depict two maps used in the fuel vapor processing system according to this embodiment, wherein the maps represent P-Q characteristics with respect to respective values of fuel vapor concentration.

### DESCRIPTION OF EMBODIMENTS

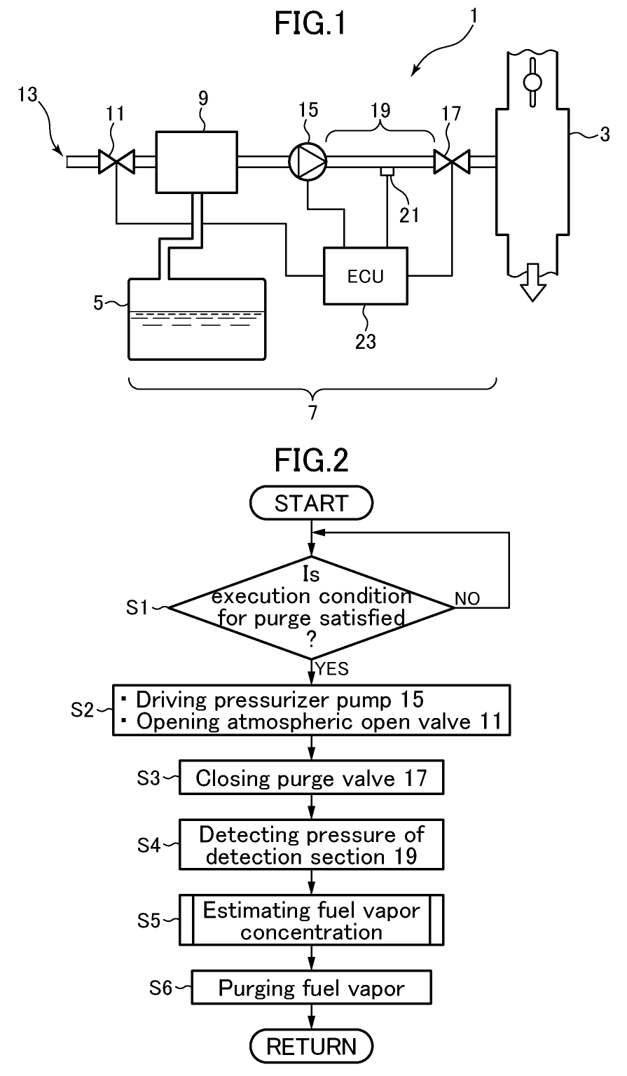

With reference to the drawings, a fuel vapor processing system according to one embodiment of the present invention will now be described. FIG. 1 is a configuration diagram of the fuel vapor processing system according to this embodiment.

As depicted in FIG. 1, the fuel vapor processing system 1 comprises a purge passage 7 extending between an intake pipe 3 of an internal combustion engine (engine intake pipe 3) and a fuel tank 5. Further, a canister 9 is provided downstream of the fuel tank 5 on the purge passage 7 to receive and store therein fuel vapor in the fuel tank 5.

For example, the canister 9 houses an adsorptive material such as activated charcoal. Thus, the fuel vapor flowing from the fuel tank 5 is adsorbed on the adsorptive material temporarily. The canister 9 is connected to an atmospheric port 13 opened to the atmosphere, via an atmospheric open valve 11.

A pressurizer pump 15 and a purge valve 17 are provided on the downstream side of the canister 9 on the purge passage 7, in this order. The pressurizer pump 15 is composed, for example, of a centrifugal pump, and designed to change a pressure in the purge passage 7, and the purge valve 17 is configured to open and close the purge passage 7. A part of the purge passage 7 between an output port of the pressurized pump 15 and the purge valve 17 is defined as a detection section 17 for use in estimating the concentration of the fuel vapor contained in the gas discharged from the canister 9 and pumped into the part of the purge passage 7. The detection section 19 is an internal space of the pipe connecting between the pressurized pump 15 and the purge valve 17. A pressure sensor 21 is provided in the detection section 19 to detect a pressure in the detection section 19.

The fuel vapor processing system 1 further comprises an ECU 23 serving as a controller for controlling various devices (components) of the vehicle, including the atmospheric open valve 11, the pressurizer pump 15, the purge valve 17 and the pressure sensor 21.

Next, an operation of the fuel vapor processing system 1 will be described in detail. FIG. 2 is a flowchart depicting the operation of the fuel vapor processing system 1. The flowchart depicted in FIG. 2 is executed at a start of engine drive, and repeatedly executed until the engine is stopped.

When a series of steps in a processing routine is started at the start of engine drive, in step S1, the fuel vapor processing system 1 (ECU 23) determines whether an execution condition for purging the fuel vapor is satisfied.

When the execution condition is satisfied, the routine proceeds to step S2. In step S2, the fuel vapor processing system 1 (ECU 23) drives the pressurizer pump 15. Further, when the atmospheric open valve 11 is in a closed state, the atmospheric open valve 11 is set to an open state in which the atmospheric port 13 is opened to the atmosphere. This operation is performed by, under control of the ECU 23, applying a drive voltage to the pressurizer pump 15 so as to drive the pressurizer pump 15 under a predetermined drive condition, and controlling the atmospheric open valve 11. In this embodiment, the predetermined drive condition for the pressurizer pump 15 is a predetermined rotational speed of the pressurizer pump 15.

In this case, it is desirable to provide a sensor for detecting that the pressurizer pump 15 is actually rotated at a rotational speed corresponding to a pump drive signal for driving the pressurizer pump 15. This makes it possible to figure out a driven state of the pressurizer pump 15 and thus improve accuracy in the concentration estimation processing.

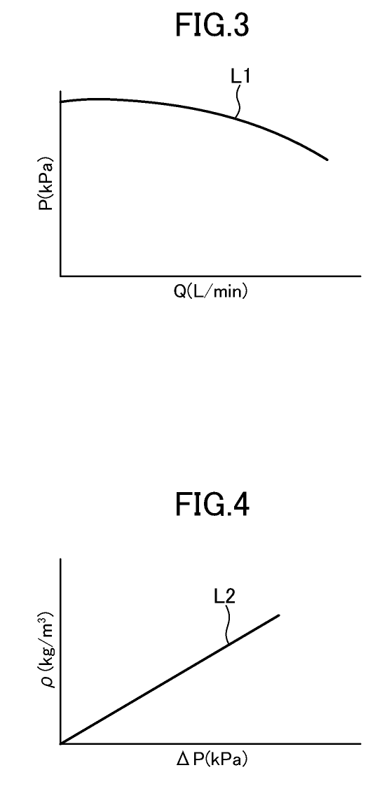

FIG. 3 is a graph depicting a P-Q characteristic of the pressurizer pump 15. The term “P-Q characteristic” herein means a characteristic regarding a relationship between a flow rate Q (L/min) of the gas obtained by the pressurizer pump 15 and a pressure P (kPa) of the gas obtained by the pressurizer pump 15, in a state where the pressurizer pump 15 is rotated at a specific rotational speed. In step S2, the pressurizer pump 15 is driven under the predetermined drive condition, e.g., at 40,000 rpm. A curve L1 depicted in FIG. 3 represents a P-Q characteristic obtainable when the pressurizer pump 15 is driven at 40,000 rpm.

In step S2, when the pressurizer pump 15 is driven under the predetermined drive condition, an airstream is generated such that it flows into the purge passage 7 via the atmospheric port 13 and the canister 9. Then, due to this airstream, the fuel vapor stored in the canister 9 flows towards the downstream side of the purge passage 7.

Subsequently, in step S3, the fuel vapor processing system 1 (ECU 23) closes the purge valve 17. Specifically, the processing in step S3 is executed when the ECU 23 operates to judge (determine) a state of the purge valve 17, and consequently the purge valve 17 is determined to be in an open state. On the other hand, when the purge valve 17 is determined to be in a closed state, the processing in step S3 is not executed. As a result of the processing in step S3, a substantially closed space having a certain volume (i.e., the detection section 19) is defined between the output port of the pressurized pump 15 and the purge valve 17.

Subsequently, in step S4, the fuel vapor processing system 1 (ECU 23) detects a pressure in the detection section 19. Specifically, in step S3, when the purge valve 17 is closed, the detection section 19 as a substantially closed space is pressurized by the pressurizer pump 15, so that the pressure in the detection section 19 is increased. Then, when the pressure in the detection section 19 reaches a certain value, it becomes impossible for the gas from the pressurizer pump 15 to be pumped into the detection section 19 anymore. Thus, the pressure in the detection section 19 becomes stable, and the flow rate Q of the gas from the pressurizer pump 15 becomes zero. Then, the ECU 23 operates to detect a value of the pressure in the detection section 19 when the flow rate Q of the gas becomes zero.

Subsequently, in step S5, the fuel vapor processing system 1 (ECU 23) estimates the fuel vapor concentration. While there are primarily two techniques as a way to estimate the fuel vapor concentration, both of the techniques utilize a fact (relationship) that the fuel vapor concentration is closely related to the pressure in the detection section 19. Specifically, when a plurality of types of gases containing particles in different concentrations are pressurized under the same pressurization condition, a gas having a relatively higher particle concentration provides a relatively higher pressure, and a gas having a relatively lower particle concentration provides a relatively lower pressure. That is, the particle concentration and the gas pressure exhibit a proportional relation. Thus, in step S5, the concentration of the fuel vapor contained in the gas residing in the detection section 19 is estimated based on a value of pressure (signal) detected when the pressure in the detection section 19 has been increased. The two techniques will be specifically described below.

In the first technique for estimating the fuel vapor concentration, in the fuel vapor processing system 1, data indicative of a relation ship of: a difference (ΔP) between a value of the pressure in the detection section 19 when the fuel vapor-free gas (the gas not containing the fuel vapor) is pumped into the detection section 19 by the pressurizer pump 15 and a value of the pressure in the detection section 19 when the fuel vapor-containing gas (the gas containing the fuel vapor) is pumped into the detection section 19 by the pressurizer pump 15; and the fuel vapor concentration (p) are preliminarily stored (in a memory), and the fuel vapor concentration is estimated based on the data.

The value (P1) of the pressure in the detection section 19 when the fuel vapor-free gas is pumped into the detection section 19 is a value preliminarily measured and stored (in the memory) in the fuel vapor processing system 1. For measuring a pressure regarding the fuel vapor-free gas, the same pump as the pressurizer pump 15 is used and driven under the same drive condition as the drive condition aforementioned for the pressurizer pump 15, i.e., at 40,000 rpm, to pump the gas into a space having the same volume as that of the detection section 19.

Further, by using each of a plurality of types of fuel vapor-containing gases having different fuel vapor concentrations, the value (P2) of the pressure in the detection section 19 after the pressurization is measured according to the same measurement method as the above. Then, with respect to each value of the fuel vapor concentration, a difference (ΔP) between the value (P1) and the value (P2) is calculated, and a map representing a relationship between the difference (ΔP) and the fuel vapor concentration (p), as depicted in FIG. 4, is created and stored (in the memory) in the fuel vapor processing system 1. As mentioned above, the concentration of particles in the gas (particle concentration) and the pressure of the gas (gas pressure) exhibit a proportional relation, so that the difference (ΔP) and the fuel vapor concentration (p) exhibit a proportional relation as indicated by the line L2 in FIG. 4. Then, when estimating the fuel vapor concentration, the ECU 23 operates to calculate the difference (ΔP) between the value (P2) detected by the pressure sensor 21, and the value (P1) of the pressure of the detection section 19 preliminarily measured when the fuel vapor-free gas has been pumped into the detection section 19. Then, the ECU 23 operates to estimate the fuel vapor concentration (p), based on the difference (ΔP) and with reference to the map as depicted in FIG. 4.

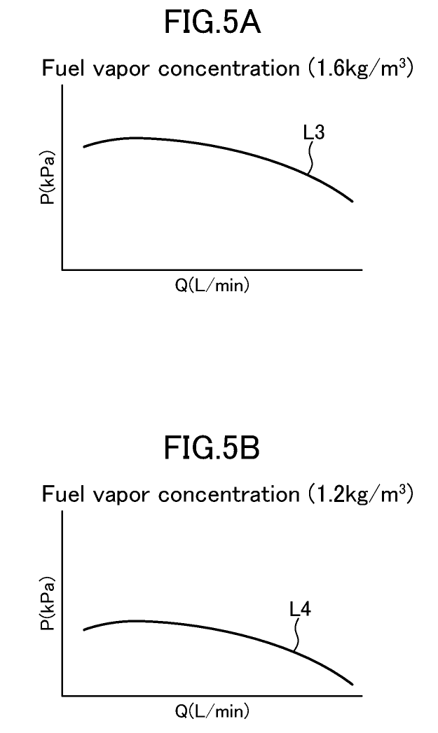

In the second technique for estimating the fuel vapor concentration, a plurality of P-Q characteristics of the pressurizer pump 15 with respect to different values of the fuel vapor concentration are preliminarily measured, and a plurality of maps representing the P-Q characteristics with respect to the respective values of the fuel vapor concentration are stored (in the memory) in the fuel vapor processing system 1, as depicted in FIG. 5A and FIG. 5B. Comparing the map depicted in FIG. 5A with the map depicted in FIG. 5B, a curve L3 depicted in FIG. 5A indicative of a P-Q characteristic regarding a gas having a relatively higher fuel vapor concentration exhibits a pressure greater than that of a curve L4 depicted in FIG. 5B indicative of a P-Q characteristic regarding a gas having a relatively lower fuel vapor concentration. Then, when estimating the fuel vapor concentration, the ECU 23 operates to select one of the maps which indicates a value of pressure coincident with that in the detection section detected by the pressure sensor 21 when the flow rate (Q) is zero, and estimate that the fuel vapor concentration in the detection region 19 is one of the values of fuel vapor concentration associated with the selected map.

After estimating the fuel vapor concentration in the detection region 19 by one of the first and second methods, the fuel vapor is purged in step S6. This step S6 is performed such that the ECU 23 operates to open and close the purge valve 17 based on predetermined duty pulses. An open-close duty of the purge valve 17 is determined based on the fuel vapor concentration estimated in step S5. Specifically, in a situation where the estimated fuel vapor concentration has a relatively higher value, an amount of the fuel vapor stored in the canister 9 is relatively larger, so that it is necessary to suppress an amount of the fuel vapor to be supplied to the engine intake pipe 3. Thus, in this situation, the purge valve 17 may be driven according to duty pulses having a relatively narrower pulse width. This makes it possible to supply an appropriate amount of the vapor fuel to the engine intake pipe 3 even when a stored amount of the fuel vapor is relatively larger.

On the other hand, in a situation where the estimated fuel vapor concentration has a relatively lower value, the amount of the fuel vapor stored in the canister 9 is relatively smaller, so that it is not necessary to suppress the amount of the fuel vapor to be supplied to the engine intake pipe 3. Thus, in this situation, the purge valve 17 may be driven according to duty pulses having a relatively wider pulse width. This makes it possible to supply a sufficient amount of the vapor fuel to the engine intake pipe 3 even when a stored amount of the fuel vapor is relatively smaller.

As mentioned above, in the fuel vapor processing system 1 according to the above embodiment, the pressurizer pump 15 is provided between the canister 9 on the purge passage 7 and the purge valve 17, thereby making it possible to generate a negative pressure for sucking from the canister 9 the fuel vapor stored in the canister 9. Thus, it becomes possible to purge the fuel vapor without operating a throttle valve.

Further, the concentration of the fuel vapor contained in the gas residing in the detection section 19 can be estimated by referring to the detection value (signal) from the pressure sensor 21 obtained after the pressure increase in the detection section 19 caused by pumping the fuel vapor-containing gas into the detection section 19, as in the above embodiment. Then, a purge processing of the fuel vapor stored in the canister 9 is performed based on the estimated fuel vapor concentration, so that it is possible to control an air-fuel ratio in cylinders with a high degree of accuracy, while taking into account an amount of the fuel vapor to be introduced into the engine intake pipe 3.

In the above embodiment, the value (P1) of the pressure in the detection section 19 when the fuel vapor-free gas is pumped into the detection section 19 is preliminarily measured and stored (in the memory) in the fuel vapor processing system 1. Alternatively, the value (P1) may be calculated every time the processing for estimating the fuel vapor concentration is executed. In this case, a map representing a P-Q characteristic of the pressurizer pump 15 when the fuel vapor-free gas is pumped into the detection section 19 may be preliminarily created and stored (in the memory). Then, every time the processing for estimating the fuel vapor concentration is executed, a value of the pressure in the detection section 19 under the predetermined drive condition of the pressurizer pump 15 may be read with reference to the map of the P-Q characteristic. This method also makes it possible to determine a value (P1) of the pressure in the detection section 19 for use in the processing for estimating the fuel vapor concentration.

In the above embodiment, one map representing a P-Q characteristic of the pressurizer pump 15 when the fuel vapor-free gas is pumped into the detection section 19 is prepared, and used during the estimation of the fuel vapor concentration. Alternatively, a plurality of maps indicative of respective different P-Q characteristics regarding the fuel vapor-free gas may be prepared. In this case, the plurality of different P-Q characteristics may be prepared with respect to respective values of temperature of gas to be pumped into the detection section 19, or respective values of atmospheric pressure of ambient air around a vehicle equipped with the fuel vapor processing system 1. More specifically, a temperature sensor for detecting a value of temperature of the gas to be pumped into the detection section 19 or a pressure sensor for detecting a value of atmospheric pressure of the ambient air may be additionally provided. Then, one of the maps indicative of the P-Q characteristics may be selectively read according to a detection value of the temperature and/or pressure sensor, or according to the detection value received by and stored (in the memory) in the ECU 23, to determine the value (P1) of the pressure in the detection section 19 based on the read map. This makes it possible to estimate the fuel vapor concentration with a high degree of accuracy, while taking into account a surrounding environment.

It is considered that, in a situation where the pressure in the detection section 19 is relatively low, a pressure change caused by the drive of the pressurizer pump 15 becomes small. Thus, the processing of detecting the pressure in the detecting section 19 is preferably executed in a rotational speed range of the pressurized pump 15 capable of increasing the pressure in the detection section 19 by a predetermined value (e.g., 5 kPa) or more. This makes it possible to estimate the fuel vapor concentration with a high degree of accuracy, while suppressing variation in detection value of the pressure sensor.

### LIST OF REFERENCE SIGNS

1: fuel vapor processing system
5: fuel tank
7: purge passage
9: canister
15: pressurizer pump
17: purge valve
19: detection section
21: pressure sensor
23: ECU

1. A method for operating a fuel vapor processing system including:
a purge passage connecting a fuel tank to an intake pipe of an internal combustion engine;
a canister connected to a downstream side of said fuel tank on said purge passage and configured to receive and store therein fuel vapor from said fuel tank;
a pressurizer pump connected to the downstream side of said canister on said purge passage;
a purge valve connected to the downstream side of said pressurizer pump on said purge passage; and
a pressure sensor configured to detect a pressure in a detection section between said pressurizer pump and said purge valve on said purge passage;
the method comprising the steps of:
determining if said engine is under a specific engine condition; and
when determined that said engine is under said specific engine condition,
closing said purge valve,
operating said pressurizer pump from a stop thereof to a predetermined condition to pump a gas, which contains the fuel vapor stored in said canister, into said detection section, and
estimating concentration of the fuel vapor in the gas residing in said detection section based on a signal from said pressure sensor detected after a pressure increase in said detection section, which has been caused by pumping the gas containing the fuel vapor into said detection section, and
controlling said purge valve to be opened so as to purge a larger amount of the fuel vapor as the estimated fuel vapor concentration is lower.

2. The method as recited in claim 1,
in estimating the concentration of the fuel vapor, the fuel vapor concentration is estimated based on a difference between: a value of a pressure in said detection section when a gas not containing the fuel vapor is pumped into said detection section by said pressurizer pump; and a detection value from said pressure sensor detected after the pressure increase in said detection section caused by pumping the gas containing the fuel vapor into said detection section.

3. The method as recited in claim 1,
the value of the pressure in said detection section when the gas not containing the fuel vapor is pumped into said detection section is a value of a pressure generated in said detection section when said pressurizer pump is driven under said predetermined drive condition.

4. The method as recited in claim 1,
wherein the fuel vapor processing system further includes a memory storing therein the value of the pressure in said detection section when the gas not containing the fuel vapor is pumped into said detection section, which has been preliminarily measured.

5. The method as recited in claim 1,
wherein the fuel vapor processing system further includes a memory storing therein data indicative of a P-Q characteristic of said pressurizer pump when the gas not containing the fuel vapor is pumped,
wherein the value of the pressure in said detection section when the gas not containing the fuel vapor is pumped into said detection section is a value of a pressure corresponding to said predetermined drive condition, indicated by said P-Q characteristic.

6. The method as recited in claim 5,
wherein the memory stores therein data indicative of a plurality of P-Q characteristics of said pressurizer pump when the gas not containing the fuel vapor is pumped,
wherein the plurality of P-Q characteristics are associated with respective values of temperature of the gas to be pumped into the detection section, and
wherein the value of the pressure in said detection section when the gas not containing the fuel vapor is pumped into said detection section is a value of a pressure determined based on data indicative of one of the plurality of P-Q characteristics associated with a value of temperature of the gas detected by a temperature sensor.

7. The method as recited in claim 5,
wherein the memory stores therein data indicative of a plurality of P-Q characteristics of said pressurizer pump when the gas not containing the fuel vapor is pumped,
wherein the plurality of P-Q characteristics are associated with respective values of outside air pressure, and
wherein the value of the pressure in said detection section when the gas not containing the fuel vapor is pumped into said detection section is a value of a pressure determined based on data indicative of one of the plurality of P-Q characteristics associated with a value of outside air pressure detected by an outside air pressure sensor.

8. The method as recited in claim 1,
wherein the fuel vapor processing system further includes a memory storing therein data indicative of a relationship of: a difference between a value of a pressure in said detection section when a gas not containing the fuel vapor is pumped into said detection section by said pressurizer pump, and a detection value from said pressure sensor detected after the pressure increase in said detection section caused by pumping the gas containing the fuel vapor into said detection section; and the fuel vapor concentration, and
wherein, in estimating the concentration of the fuel vapor, the fuel vapor concentration is estimated based on said data.

9. The method as recited in claim 1,
wherein the fuel vapor processing system further includes a memory storing therein data indicative of a plurality of P-Q characteristics of the pressurizer pump with respect to respective values of fuel vapor concentration, and
wherein, in estimating the concentration of the fuel vapor, one of the plurality of P-Q characteristics which corresponds to a pressure in said detection section detected by the pressure sensor is selected, and the fuel vapor concentration is estimated as one of the values of fuel vapor concentration associated with the selected P-Q characteristic.

10. A fuel vapor processing system comprising:
a purge passage connecting a fuel tank to an intake pipe of an internal combustion engine;
a canister connected to a downstream side of said fuel tank on said purge passage and configured to receive and store therein fuel vapor from said fuel tank;
a pressurizer pump connected to the downstream side of said canister on said purge passage;
a purge valve connected to the downstream side of said pressurizer pump on said purge passage;
a pressure sensor configured to detect a pressure in a detection section between said pressurizer pump and said purge valve on said purge passage; and
a controller configured to:
determine if said engine is under a specific engine condition; and
when determined that said engine is under said specific engine condition,
control said purge valve to be closed,
control said pressurizer pump to be driven from a stop thereof to a predetermined condition to pump a gas, which contains the fuel vapor stored in said canister, into said detection section, and
estimate concentration of the fuel vapor in the gas residing in said detection section based on a signal from said pressure sensor detected after a pressure increase in said detection section, which has been caused by pumping the gas containing the fuel vapor into said detection section, and
control said purge valve to be opened so as to purge a larger amount of the fuel vapor as the estimated fuel vapor concentration is lower.

11. The fuel vapor processing system as recited in claim 10,
wherein said controller is operable to estimate the fuel vapor concentration, based on a difference between: a value of a pressure in said detection section when a gas not containing the fuel vapor is pumped into said detection section by said pressurizer pump; and a detection value from said pressure sensor detected after the pressure increase in said detection section caused by pumping the gas containing the fuel vapor into said detection section.

12. The fuel vapor processing system as recited in claim 10,
wherein the value of the pressure in said detection section when the gas not containing the fuel vapor is pumped into said detection section is a value of a pressure generated in said detection section when said pressurizer pump is driven under said predetermined drive condition.

13. The fuel vapor processing system as recited in claim 10, further comprising
a memory storing therein the value of the pressure in said detection section when the gas not containing the fuel vapor is pumped into said detection section, which has been preliminarily measured.

14. The fuel vapor processing system as recited in claim 10, further comprising
a memory storing therein data indicative of a P-Q characteristic of said pressurizer pump when the gas not containing the fuel vapor is pumped,
wherein the value of the pressure in said detection section when the gas not containing the fuel vapor is pumped into said detection section is a value of a pressure corresponding to said predetermined drive condition, indicated by said P-Q characteristic.

15. The fuel vapor processing system as recited in claim 14,
wherein the memory stores therein data indicative of a plurality of P-Q characteristics of said pressurizer pump when the gas not containing the fuel vapor is pumped,
wherein the plurality of P-Q characteristics are associated with respective values of temperature of the gas to be pumped into the detection section, and
wherein the value of the pressure in said detection section when the gas not containing the fuel vapor is pumped into said detection section is a value of a pressure determined based on data indicative of one of the plurality of P-Q characteristics associated with a value of temperature of the gas detected by a temperature sensor.

16. The fuel vapor processing system as recited in claim 14,
wherein the memory stores therein data indicative of a plurality of P-Q characteristics of said pressurizer pump when the gas not containing the fuel vapor is pumped,
wherein the plurality of P-Q characteristics are associated with respective values of outside air pressure, and
wherein the value of the pressure in said detection section when the gas not containing the fuel vapor is pumped into said detection section is a value of a pressure determined based on data indicative of one of the plurality of P-Q characteristics associated with a value of outside air pressure detected by an outside air pressure sensor.

17. The fuel vapor processing system as recited in claim 10, further comprising
a memory storing therein data indicative of a relationship of: a difference between a value of a pressure in said detection section when a gas not containing the fuel vapor is pumped into said detection section by said pressurizer pump, and a detection value from said pressure sensor detected after the pressure increase in said detection section caused by pumping the gas containing the fuel vapor into said detection section; and the fuel vapor concentration,
wherein said controller is operable to estimate the fuel vapor concentration, based on said data.

18. The fuel vapor processing system as recited in claim 10, further comprising
a memory storing therein data indicative of a plurality of P-Q characteristics of the pressurizer pump with respect to respective values of fuel vapor concentration,
wherein said controller is operable to select one of the plurality of P-Q characteristics which corresponds to a pressure in said detection section detected by the pressure sensor, and estimate that the fuel vapor concentration is one of the values of fuel vapor concentration associated with the selected P-Q characteristic.
